(19) United States
(12) Patent Application Publication
(10) Pub. No.: US 2009/0185675 A1
(43) Pub. Date: Jul. 23, 2009

(54) METHOD AND DEVICE FOR INVOKING EARPIECE APPLICATION PROGRAM

(75) Inventor: Qi Cheng, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Shenzhen Huawei Communication Technologies Co., Ltd., Shenzhen (CN)

(21) Appl. No.: 12/356,372

(22) Filed: Jan. 20, 2009

(30) Foreign Application Priority Data
Jan. 22, 2008 (CN) 200810004373.0
Nov. 14, 2008 (CN) PCT/CN2008/073078

(51) Int. Cl. H04M 1/00

(52) U.S. Cl. 379/422

(57) ABSTRACT

The embodiments of the present invention disclose a method and a device for invoking earpiece application program. The method includes: detecting whether an earpiece is connected or not; and displaying a prompt list of all applications supporting the earpiece in terminal equipment when detecting that the earpiece is connected. The embodiments of the present invention further disclose terminal equipment.

### CROSS-REFERENCE TO RELATED APPLICATIONS

This application claims priority to Chinese Patent Application No. 200810004373.0, filed Jan. 22, 2008 and International Patent Application No. PCT/CN2008/073078, filed Nov. 14, 2008, both of which are hereby incorporated by reference in their entirety.

### FIELD OF THE INVENTION

The present invention relates to the communication field, and more particularly to a method and a device for invoking earpiece application program.

### BACKGROUND

With the development of the society, people expect a more convenient and efficient life and hope to obtain information at any time and anywhere. Thus, terminal equipments with functions of camera, audio, video, network service, game playing, and positioning have been increasingly popular with a wide range of consumer groups.

With the continuous introduction of conventional consumer electronic functions and computer functions, a handheld terminal has gone beyond the conventional orientation of serving as a conventional conversation tool for merely providing voice and short message services, and has been transformed into a communication pivot for connecting the modern people to the digital world, thereby becoming an “omnipotent” digital terminal. This portrays a beautiful painting about the development of the terminal in the future: in the digital times, the handheld terminal will be integrated with diversified functions and become the communication pivot for connecting anyone and anything; and with the aid of the handheld terminal, people can “master” the whole digital world “in one hand.”

Although current terminal equipments all support an earpiece to achieve functions of answering phone calls, listening to radio, enjoying music, etc., some of the functions may be hidden deeply in a menu tree structure, so that the user has to open the menu hierarchy one by one to search for the functions, which are rather trivial. With the development of handheld terminal technology, the functions and the performance of the operating system and application software in handheld terminal equipments are greatly improved. Most of the handheld terminal equipments have functions of built-in radio, media player, and the like, and further support plug-in earpieces in the hardware structure.

During the process of realizing the present invention, the inventor found that the prior art has at least the following problems. When the user carries out operations such as making phone calls, listening to radio, and enjoying music by using an earpiece, since the menu tree structure of the terminal equipment is rather complicated and some audio functions may be hidden deeply in the menu tree structure, the user has to open the menu hierarchy one by one to search for the functions, which are rather trivial.

### SUMMARY

An embodiment of the present invention provides a method for invoking earpiece application program, which includes:

detecting whether an earpiece is connected; and

displaying a prompt list of all applications supporting the earpiece in a terminal equipment when detecting that the earpiece is connected.

Another embodiment of the present invention further provides a terminal equipment including:

a detection module, adapted to detect whether an earpiece is connected; and

a display module, adapted to display a prompt list of all applications supporting the earpiece in the terminal equipment when the detection module detects that the earpiece is connected.

Another embodiment of the present invention further provides a device for invoking an earpiece application program, including:

a detection module, adapted to detect whether a terminal equipment has an earpiece connected thereto; and

a display module, adapted to display a prompt list of all applications supporting the earpiece in the terminal equipment when the detection module detects that the earpiece is connected.

### BRIEF DESCRIPTION OF THE DRAWINGS

FIG. 1 is a flow chart of a method for invoking an earpiece application program according to an embodiment of the present invention;

FIG. 2 is a structural view of a terminal equipment according to an embodiment of the present invention; and

FIG. 3 is a structural view of a device for invoking an earpiece application program according to an embodiment of the present invention.

### DETAILED DESCRIPTION

In an embodiment of the present invention, a method for invoking an earpiece application program is provided. When it is detected that terminal equipment has an earpiece connected thereto, a prompt list of all applications supporting the earpiece in the terminal equipment is displayed for being selected by a user, so that the efficiency for carrying out operations such as listening to a radio, enjoying music, and making phone calls by the user through using the earpiece is improved, thereby enhancing the overall usability of the terminal equipment.

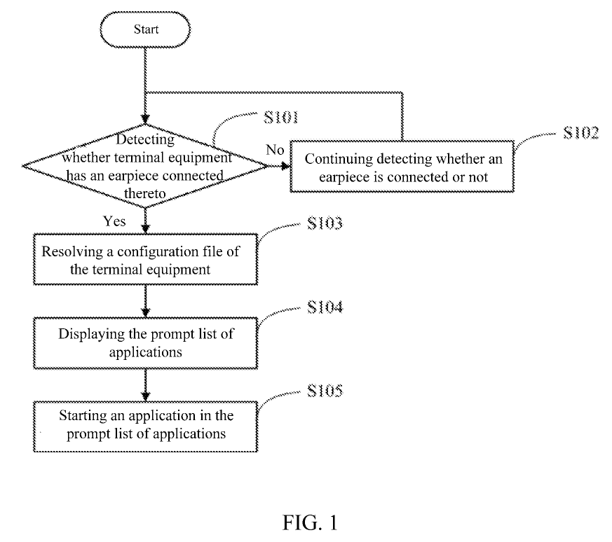

FIG. 1 is a flow chart of a method for invoking earpiece application program according to an embodiment of the present invention. The method specifically includes the following steps.

In Step S101, it is detected whether terminal equipment has an earpiece connected thereto.

Upon being powered on and initialized, the terminal equipment is detected whether to have the earpiece connected thereto, which may be implemented in a plurality of manners. For a wired earpiece, the detection manners include an interrupt manner, a general purpose input/output (GPIO) manner, and an interface polling manner. For a wireless earpiece, the detection manner may be detecting a corresponding wireless signal. If it is detected that no earpiece is connected, Step S102 is performed; otherwise, Step S103 and its subsequent steps are performed.

In Step S102, it continues detecting whether an earpiece is connected or not.

In Step S103, a configuration file of the terminal equipment is resolved. When software of the terminal equipment is integrated, a configuration file is added at the software side. The configuration file describes names of all applications supporting the earpiece in the terminal equipment and start entries of corresponding identifiers (IDs), for example, listening to the radio, enjoying music, etc. Furthermore, relevant applications can be modified simply through modifying the corresponding configuration file. A format of the configuration file may be configured as “Application Name=Application Start ID”. The application start ID is a code for uniquely identifying an application, which is a hexadecimal value beginning with 0x. The configuration file may further include some configuration information about other applications in the terminal equipment, which will not be described herein in detail. The format of the above configuration file involving the earpiece applications is shown as follows:

# this is a demo configuration file
#eg. app_name=app_ID
#earpiece_app_1=0x3837372f
earpiece_app_1=0x38545446
earpiece_app_2=0x34574335
earpiece_app_3=0x54772543

The terminal equipment resolves the configuration file stored in the equipment itself and extracts the names of the applications supporting the earpiece and corresponding hexadecimal application IDs respectively, line by line in a string scanning manner.

Further in step S103, upon detecting for the first time after the terminal equipment is powered on that the earpiece is connected to the terminal equipment, the configuration file is resolved and then the resolved configuration file is stored. Then, when the terminal equipment is subsequently detected that an earpiece is connected, the resolved configuration file may be displayed directly. Alternatively, the configuration file is resolved and stored once the terminal equipment is powered on, and then, once it is detected that the earpiece is connected before the terminal equipment is powered off, the resolved configuration file is displayed directly. Alternatively, the terminal equipment resolves the configuration file each time when the terminal equipment is detected to have the earpiece connected thereto and then displays the resolved configuration file.

In Step S104, a prompt list of applications is displayed.

After the configuration file is resolved, a display screen of the terminal equipment shows a prompt list of all applications supporting the earpiece in the terminal equipment for being selected by the user, as shown in Table 1.

TABLE 1

1 Start the radio
2 Start the media player
3 Enter the phone book
4 Close the dialog box

In Step S105, an application in the prompt list is started. When the user of the terminal equipment selects one application option from the above prompt list of applications, the terminal equipment starts a corresponding application according to a corresponding ID of the selected application option. Taking the above format of the configuration file and Table 1 as an example, it is assumed that the application name “earpiece_app_{—}1” in the above configuration file corresponds to the “Start the multimedia player” in Table 1 and a corresponding ID start entry is “0x38545446”. When the terminal equipment is detected to have an earpiece connected thereto, the “Start the multimedia player” corresponding to the application name “earpiece_app_{—}1” is directly displayed on the display screen of the terminal equipment through resolving the above configuration file. When the user selects the “Start the multimedia player,” the terminal equipment starts a multimedia player via the ID start entry “0x38545446” corresponding to the “earpiece_app_{—}1”.

In the embodiments of the present invention, when the terminal equipment is detected to have the earpiece connected thereto, the prompt list of all applications supporting the earpiece in the terminal equipment is directly displayed for being selected by the user, so that the efficiency for carrying out operations such as listening to the radio, enjoying music, and making phone calls by the user of the terminal equipment through using the earpiece is greatly improved, thereby enhancing the overall usability of the terminal equipment. Moreover, with the embodiments of the present invention, the software configurability is further improved, and relevant applications can be modified simply through modifying the configuration file correspondingly.

FIG. 2 is a structural view of terminal equipment according to an embodiment of the present invention. The terminal equipment in this embodiment specifically includes a detection module 21 and a display module 22. The detection module 21 is adapted to detect whether an earpiece is connected or not. The display module 22 is adapted to display a prompt list of all applications supporting the earpiece in the terminal equipment when the detection module 21 detects that an earpiece is connected.

The terminal equipment in this embodiment may further include a storage module 23 and a resolution module 25. The storage module 23 is adapted to store a configuration file that is a basis for the display module 22 to display the prompt list of applications. The resolution module 25 is adapted to resolve the configuration file for being displayed by the display module 22.

The terminal equipment in this embodiment may further include a start module 24 adapted to start an application when the user of the terminal equipment selects one corresponding application option in the prompt list of applications displayed by the display module 22.

In one embodiment of the present invention, when the detection module 21 detects that an earpiece is connected, the display module 22 displays the prompt list of applications obtained through resolving the configuration file by the resolution module 25. The resolution module 25 may resolve and store the configuration file once the terminal equipment is powered on, and then the display module 22 directly displays the resolved configuration file as required. Alternatively, the resolution module 25 may resolve and store the configuration file when it is detected for the first time that an earpiece is connected after the terminal equipment is powered on, and then the display module 22 directly displays the resolved configuration file once it is detected that the earpiece is connected. In a further alternative embodiment, the resolution module 25 may resolve the configuration file each time when the detection module 21 detects that an earpiece is connected and then the display module 22 displays the resolved configuration file.

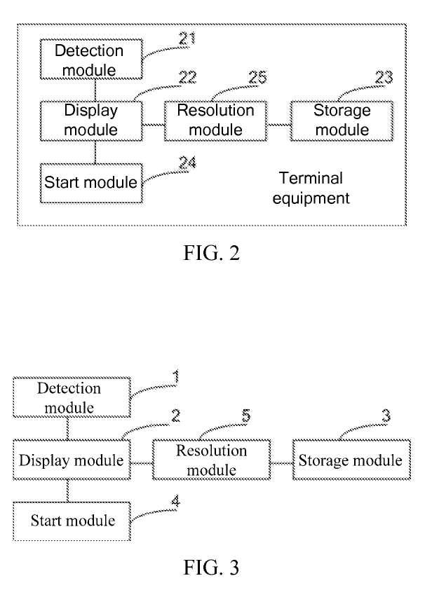

FIG. 3 is a structural view of a device for invoking earpiece application program according to an embodiment of the present invention. The device specifically includes a detection module 1 and a display module 2. The detection module 1 is adapted to detect whether terminal equipment has an earpiece connected thereto. The display module 2 is adapted to display a prompt list of all applications supporting the earpiece in the terminal equipment according to a detection result received from the detection module 1.

The device for invoking earpiece application program in the embodiments of the present invention further includes a storage module 3, a start module 4, and a resolution module 5. The storage module 3 is adapted to store a configuration file that is a basis for the display module 2 to display the prompt list of applications. The start module 4 is adapted to start an application when the user of the terminal equipment selects one corresponding application option in the prompt list of applications displayed by the display module 2. The resolution module 5 is adapted to resolve the configuration file for being displayed by the display module.

In some embodiments of the present invention, when the detection module 1 detects that an earpiece is connected, the display module 2 displays the prompt list of applications obtained through resolving the configuration file by the resolution module 5. The resolution module 5 may resolve and store the configuration file once the terminal equipment is powered on, and then the display module 2 directly displays the resolved configuration file as required. In some alternative embodiments, the resolution module 5 may resolve and store the configuration file when it is detected for the first time that the earpiece is connected after the terminal equipment is powered on, and then the display module 2 may directly display the resolved configuration file once it is detected that an earpiece is connected. In some further alternative embodiments, the resolution module 5 may resolve the configuration file each time when the detection module 1 detects that the earpiece is connected and then the display module 2 displays the resolved configuration file.

In the embodiments of the present invention, when the detection module 1 detects that the terminal equipment has an earpiece connected thereto, the display module 2 directly displays the prompt list of all applications supporting the earpiece in the terminal equipment for being selected by the user, so that an efficiency for carrying out operations such as listening to the radio, enjoying music, and making phone calls by the user of the terminal equipment through using the earpiece is greatly improved, thereby enhancing the overall usability of the terminal equipment. Moreover, with the embodiments of the present invention, the software configurability is further improved, and relevant applications can be modified simply through modifying the configuration file correspondingly.

Through the above descriptions of the embodiments, those skilled in the art should clearly understand that the present invention may be realized through combining software with a necessary universal hardware platform. Alternatively, it may be realized through dedicated hardware. In most cases, the former manner is preferred. Based on such understanding, the technical solutions of the present invention or parts of the technical solutions of the present invention making contributions to the prior art are substantially presented in the form of a software product. The obtained software product is stored in a storage medium, and includes a number of instructions for executing the method described in the embodiments of the present invention by computer equipment (e.g., a personal computer, server, network equipment, and the like).

Though the present invention has been disclosed above through some preferred embodiments, they are not intended to limit the present invention. It will be apparent to those skilled in the art that various modifications and variations can be made to the structure of the present invention without departing from the scope or spirit of the invention. In view of the foregoing, it is intended that the present invention cover modifications and variations of this invention provided that they fall within the scope of the following claims and their equivalents.

What is claimed is:

1. A method for invoking an earpiece application program, comprising:
detecting whether an earpiece is connected to a terminal equipment; and
displaying a prompt list of all applications supporting the earpiece in the terminal equipment when detecting that the earpiece is connected.

2. The method according to claim 1, wherein the detecting whether an earpiece is connected to a terminal equipment is achieved by one of an interrupt manner, a general purpose input/output (GPIO) manner, and an interface polling manner.

3. The method according to claim 1, further comprising:
adding a configuration file in advance when software of the terminal equipment is integrated, wherein the configuration file describes names of all the applications supporting the earpiece in the terminal equipment and start entries of corresponding identifiers (IDs);
the displaying of the prompt list comprises: (1) resolving the configuration file; and (2) displaying the prompt list of all the applications supporting the earpiece in the terminal equipment according to a resolution result.

4. The method according to claim 3, wherein the configuration file comprises a format of the names of the applications and the corresponding IDs, and each of the IDs uniquely identifies one of the applications supporting the earpiece.

5. The method according to claim 2, further comprising:
adding a configuration file in advance when software of the terminal equipment is integrated, wherein the configuration file describes names of all the applications supporting the earpiece in the terminal equipment and start entries of corresponding IDs;
the displaying of the prompt list comprises: (1) resolving the configuration file; and (2) displaying the prompt list of all the applications supporting the earpiece in the terminal equipment according to a resolution result.

6. The method according to claim 5, wherein the configuration file comprises a format of the names of the applications and the corresponding IDs, and each of the IDs uniquely identifies one of the applications supporting the earpiece.

7. The method according to claim 1 further comprising:
selecting one application option indicative of an application from the prompt list of applications; and
starting the application using an ID corresponding to the application option.

8. A terminal equipment, comprising:
a detection module adapted to detect an earpiece is connected; and
a display module adapted to display a prompt list of all applications supporting the earpiece in the terminal equipment when the detection module detects that the earpiece is connected.

9. The terminal equipment according to claim 8, further comprising:
a storage module adapted to store a configuration file which is a basis for the display module to display the prompt list of applications; and
a resolution module adapted to resolve the configuration file for being displayed by the display module.

10. The terminal equipment according to claim 8, further comprising:
a start module, when a user of the terminal equipment selects one application option in the prompt list of applications displayed by the display module, adapted to start the application associated with the application option.

11. A device for invoking earpiece application program, comprising:
a detection module adapted to detect whether terminal equipment has an earpiece connected thereto; and
a display module adapted to display a prompt list of all applications supporting the earpiece in the terminal equipment when the detection module detects that the earpiece is connected.

12. The device according to claim 1 1, further comprising:
a storage module adapted to store a configuration file; and
a resolution module adapted to resolve the configuration file for being displayed by the display module.

13. The device according to claim 11, further comprising:
a start module, when a user of the terminal equipment selects one application option in the prompt list of applications displayed by the display module, adapted to start an application associated with the application option.
